(19) United States
(12) Patent Application Publication
(10) Pub. No.: US 2008/0255961 A1
(43) Pub. Date: Oct. 16, 2008

(54) PRODUCT INFORMATION DISPLAY AND PURCHASING

(76) Inventor: Carl Livesey, Wigan (GB)

Correspondence Address: BARLOW, JOSEPHS & HOLMES, LTD., 101 DYER STREET, 5TH FLOOR, PROVIDENCE, RI, 02903, US

(21) Appl. No.: 11/944,689

(22) Filed: Nov. 26, 2007

(30) Foreign Application Priority Data
Apr. 14, 2007 (GB) 0707216.8
Nov. 16, 2007 (GB) 0722532.9

(51) Int. Cl. G06Q 30/00

(52) U.S. Cl. 705/27

(57) ABSTRACT

A method of providing additional information to a viewer of a moving image file is disclosed. The method includes the steps of providing one or more tags within the moving image file indicating the existence of additional product information; visually indicating the existence of the tags alongside or over the moving image; detecting a request to view the product information associated with the one or more tags; pausing the moving image; and displaying the requested product information over the paused image.

The present invention relates to a method and system for providing product information to viewers of a moving image file and to a method and system operable in connection therewith for the purchase of such products.

Commonly, viewers of movies, television programs or other moving image media are greatly influenced by such media. In particular, viewers may admire actors involved and clothing worn or other products utilised by those actors in the viewed media. Typically, obtaining information as to the exact identity of such products is not straightforward and may involve researching the matter in other media such as newspapers or magazines or on fans' websites. Having obtained this information as to product identity, it may then require further research to determine if a product is available for sale and locate a retail channel by which the product may be obtained.

It is therefore an object of the present invention to provide a system and method by which these problems may at least partially alleviated or overcome.

According to a first aspect of the present invention there is provided a method of providing additional information to a viewer of a moving image file comprising the steps of: providing one or more tags within the moving image file indicating the existence of additional product information; visually indicating the existence of said tags alongside or over the moving image; detecting a request to view said product information associated with said one or more tags; pausing said moving image; and displaying said requested product information over said paused image.

By use of the above method, a viewer can easily tell when there is further information available relating a product and can readily access that information.

The visual indication of the existence of a tag may be automatic or may be in response to viewer action. The viewer action may be a selection of a tag visual indication display mode. The tag visual indication display mode may toggle between enabled and not enabled. Alternatively, the tag visual indication display mode may be enabled temporarily in response to viewer selection or request. In such cases, the mode may be enabled for a limited time period, say a few seconds, or for a duration dependent upon the image file, say until the end of a current scene. Additionally or alternatively, tag visual indication may be in response to viewer selection of a particular area of the displayed image. The area may be the area of the image wherein the associated product is displayed or may be another dedicated area of the image. The visual indication may be displayed for a limited time period, say a few seconds, or for a duration dependent upon the image file, say until the end of a current scene.

The visual indication of the existence of a tag may comprise the display of an product icon. The product icon may be displayed over the tagged product or may be displayed in an icon display area. The icon display area may be a bar provided along one edge of the display area. The product icon may comprise a representation of the associated product. The representation may be a stylised representation or may be a photographic type image.

Additionally or alternatively, the tagged product may be visually highlighted within the image. This visual highlighting may be momentary, intermittent or constant as desired. In some implementations, this highlighting may take place in response to a viewer request.

The displayed information may be displayed in a window or dialog box provided over the paused image. The displayed information may contain any of the following: a description of the qualities of the product, one or more images of the product, the name of the manufacturer and purchasing details for the product.

Viewer requests are preferably made using suitable control means. The control means may be any type of control means suitable for interfacing with the system used to play and/or display the image file. Such suitable types of control means may include control interfaces provided directly upon the system, keyboards or keypads connected to the system by any suitable wired or wireless link, cursor directing devices connected to the system by any suitable wired or wireless link or any other control unit.

The system may comprise an integrated device or one or more connected devices. Suitable systems for playing and/or displaying the image file may include computers or may include televisions and televisions operated in conjunction with a media player such as a DVD player, games console or television signal decoder or through a mobile technology device

According to a second aspect of the present invention there is provided a system for providing additional information to viewers of a moving image file comprising the steps of: file reading means for reading the moving image content of said moving image file and detecting the presence of one or more tags indicating the existence of associated product information within the moving image file; display means operable to display the moving image content of the moving image file and to display a visual indication of the existence of said tags alongside or over the moving image; viewer actuable means for requesting the display of product information associated with said one or more tags wherein in response to the viewer actuabe means the display means is operable to pause the moving image and display the requested information over the paused image.

The system of the second aspect of the present invention may incorporate any or all features of the first aspect of the present invention as desired or as appropriate.

According to a third aspect of the present invention there is provided an enhanced moving image file format comprising a moving image file; one or more tags; and information associated with said tags.

The file format of the third aspect of the present invention may incorporate any or all features of the first or second aspects of the present invention as desired or as appropriate.

According to a fourth aspect of the present invention there is provided a method of facilitating product sales comprising the steps of: displaying additional information to a viewer in accordance with the first aspect of the present invention wherein the displayed information relates to a particular product or products displayed on screen and wherein the displayed information includes a selectable purchase icon, selection of which enables the connection of the viewer to an electronic commerce interface, for the purchase of said product.

The method of the fourth aspect of the present invention may incorporate any or all features of the first, second or third aspects of the present invention as desired or as appropriate.

In this manner, a viewer can readily order a product seen in a viewed image file.

The selectable purchase icon may be revealed by scrolling over one or more regions of the image. In particular the selectable purchase icon may be revealed by scrolling over a product icon in the dialog box or along the icon display area.

The purchase icon may be selected using suitable control means. The control means may be any type of control means mentioned in relation to the previous aspects of the present invention. The control means may also be used to operate the commerce interface.

Selection of the purchase icon may connect the viewer directly to said commerce interface. Alternatively, selection of the purchase icon may result in the addition of the product to a shopping list. After the product is added to the shopping list, the viewer may opt either to continue viewing the image file or to complete the purchasing process. The viewer may additionally or alternatively opt to complete the purchasing process at any time by selecting a displayed checkout icon.

The checkout icon may also be displayed in the icon display area during normal playing of the moving image file. Selection of the checkout icon may allow the viewer to review their shopping list before completing the purchase process. Additionally or alternatively, actuation of a particular control button on the control means may be equivalent to selection of the checkout icon.

The commerce interface may be any suitable commerce interface. In particular it may be an electronic commerce interface operable in response to input of viewer and product details to verify an order and subsequently pass on order details to a manufacturer or distributor enabling the order to be fulfilled. Typically, the commerce interface may be operated on a remote server.

Once connected to the commerce interface, the viewer must enter and/or confirm their billing and/or delivery details. In some implementations, it is possible that the viewer may merely confirm previously entered billing and/or delivery details. Upon confirmation from the viewer of the billing and/or delivery details, the interface is operable to verify the order. If the order is verified, a confirmation message is communicated to the viewer. The viewer may then choose to return to normal operation of the viewing system by selecting an icon or otherwise.

According to a fifth aspect of the present invention there is provided a system for facilitating product sales comprising: a system for providing additional information to viewers of a moving image file according to the second aspect of the present invention, wherein the displayed information relates to a particular product or products displayed on screen and wherein the displayed information includes a selectable purchase icon, the system further comprising: viewer operated control means for selecting said selectable purchase icon; and data transmission means operable to in response to the selection of said selectable purchase icon to enable connection of the system to an electronic commerce interface, for the purchase of said product.

The system of the fifth aspect of the present invention may incorporate any or all features of the fourth aspect of the present invention as desired or as appropriate.

In order that the invention is more clearly understood, it will be described in greater detail below, by way of example only, and with reference to the accompanying drawings in which:

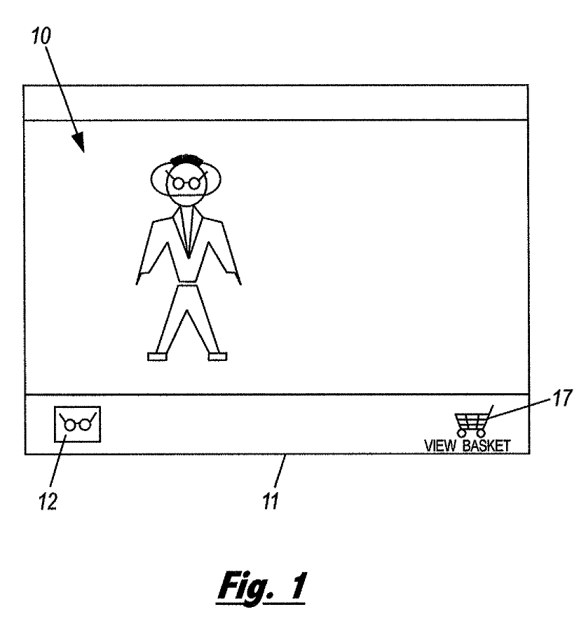

FIG. 1 shows an exemplary scene from a moving image file as it is displayed in an implementation of the present invention;

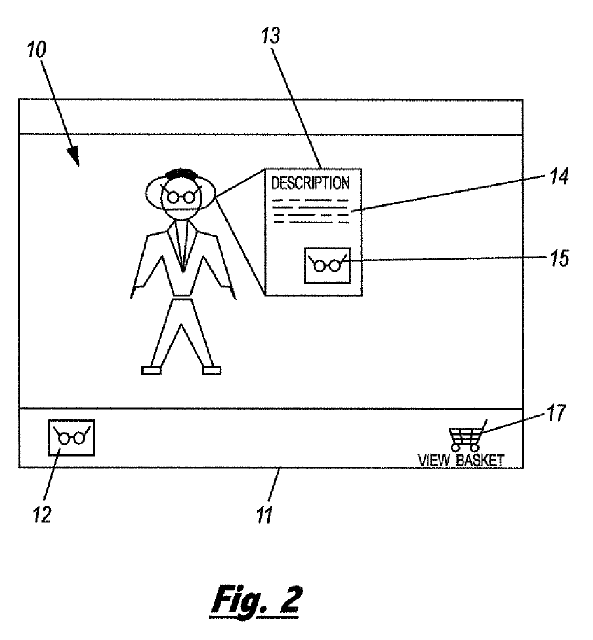

FIG. 2 illustrates the display of information about a featured product in an implementation of the present invention;

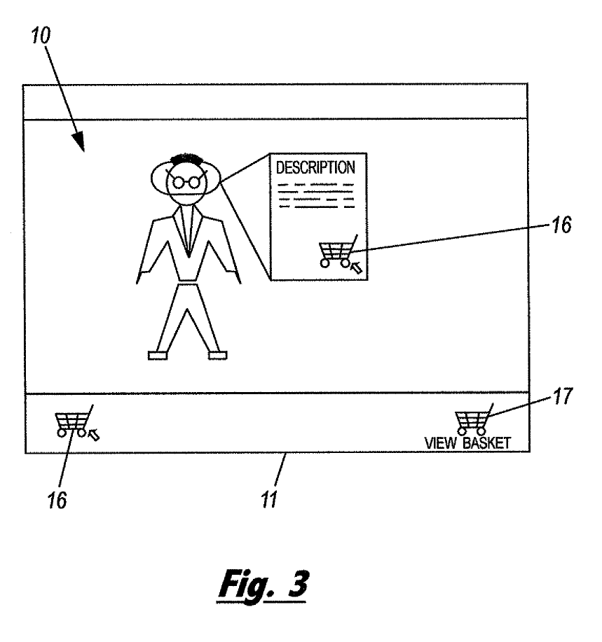

FIG. 3 illustrates the display after a product icon is scrolled over in an implementation of the present invention;

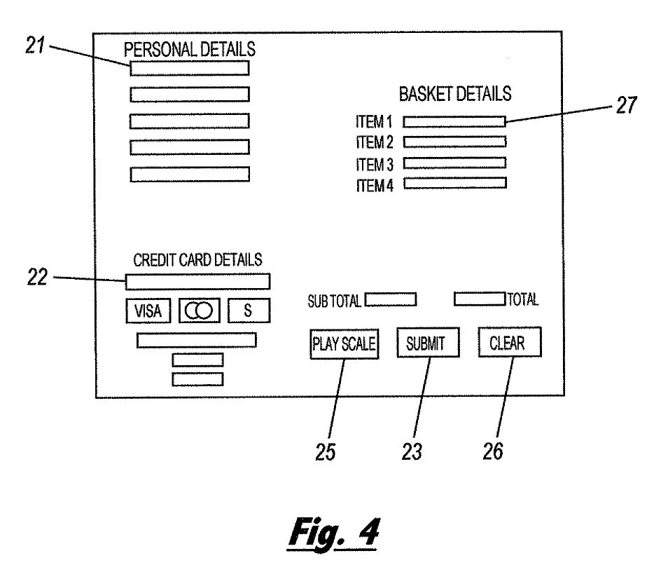

FIG. 4 illustrates an onscreen interface suitable for entering billing details in an implementation of the present invention;

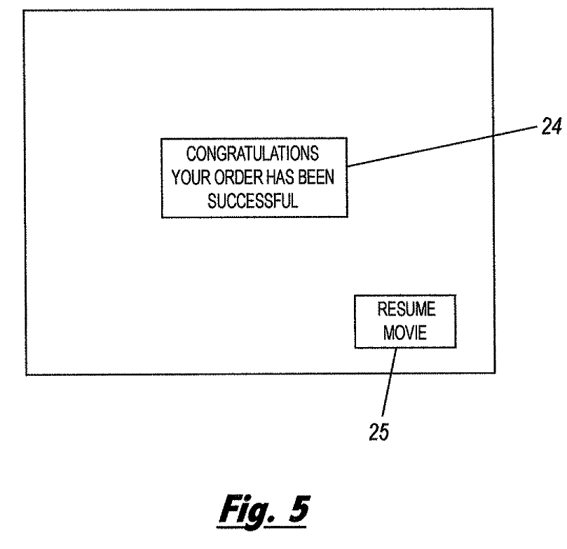

FIG. 5 illustrates the display after completion of an order in an implementation of the present invention;

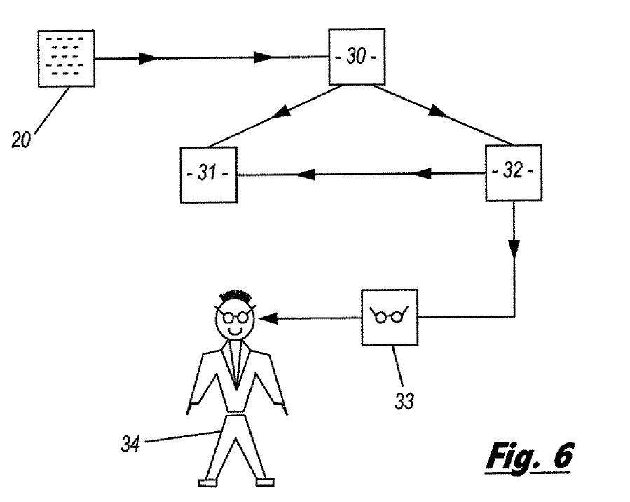

FIG. 6 is a schematic block diagram of a means by which a viewers order may be checked and fulfilled in an implementation of the present invention; and

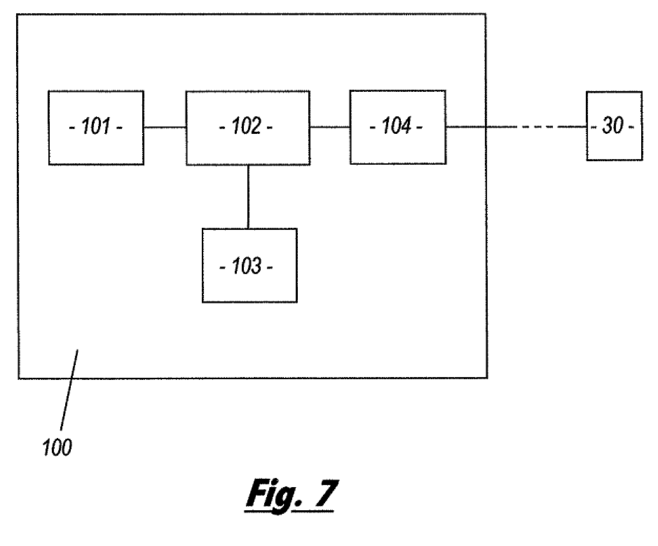

FIG. 7 is a schematic block diagram of a viewing apparatus or system suitable for facilitating the implementation of the present invention.

The present invention provides a method by means of which a viewer of a moving image file (typically a film or computer game or television programme) may gain information upon and if desired purchase products seen in the moving image file. In the method of the invention a moving image file is displayed on a display unit and the viewer is provided with a suitable control means. The moving image file contains one or more tags indicating the existence of additional product information. The existence of said tags is displayed to the viewer along with the moving image file in response to a viewer selection, request or action. The viewer may then request the display of said information and if so minded, order the associated product.

Turning now to FIG. 1, an exemplary scene 10 from a moving image file is displayed on the display device. In FIG. 1, a viewer selection of a tag visual indication display mode has been made. Accordingly, the scene 10 is displayed with an icon bar 11 at the bottom of the image. If the tag visual indication display mode is not selected, the image file is displayed in the same manner as a conventional image file. The tag visual indication display mode can be temporary or can persist until the viewer selection is reversed. The selection may be made by actuating a suitable input on the control means. If a tagged product appears within the scene, a selectable icon 12 is displayed on the icon bar. Typically, as is shown in respect of the spectacles in FIG. 1, the icon may be pictorially representative of the icon that it is associated with. This enables the viewer to identify the product and to distinguish between two or more icons if there are two or more tagged products present in the displayed scene. Additionally or alternatively, the product may be highlighted either constantly or momentarily within the moving image. In one particular implementation, the product is highlighted when the viewer scrolls a cursor over the area of the image where the product is positioned.

The icon 12 may be selected by use of the control means. This may be achieved by actuating a dedicated control input. Alternatively, if the control device is suitable (for instance, a computer mouse or similar), the viewer may directly select the product by scrolling a cursor over the product.

Upon selection, the image file is paused and, as is illustrated in FIG. 2, information relating to the product is displayed. The information may be displayed in a pop up window 13 provided over the paused image, as is shown in FIG. 2. Alternatively, the information may be displayed in an information bar alongside the paused image. The information may include a description of the qualities of the product 14, one or more images of the product 15, the name of the manufacturer and the price.

The displayed information also includes a selectable purchase icon 16, in this case, in the form of a shopping cart. In the presently described implementation, the purchase icon 16 appears if the viewer scrolls over either the product icon 12 or the product image 15 or operates a dedicated control input. The viewer may then select the purchase icon using the control means in any suitable manner. By selecting this icon 16, the product is added to a customers shopping list. The viewer can review and edit their shopping list and proceed to purchase by selecting the shopping cart icon 17 displayed on the icon bar. Alternatively, the selection may be made by actuating a dedicated control input on the control means.

After adding the product to their shopping list, the viewer may choose to complete the purchase at this time or may choose to continue viewing the image file. Typically, this may be possible by selecting suitable onscreen icons or buttons or by operating a suitable input on the control means.

When a viewer chooses to complete their purchase, either directly after adding a product to their shopping list or upon finishing viewing the file, the viewer is required to enter personnel details 21 and billing details 22, via a suitable on screen interface 20, which may be of the type shown in FIG. 4. In some implementations, the viewer may have saved such details or may opt to save such details and thus need not re-enter the details. The viewer may also view and/or edit the shopping list 27. Once the details are entered, the viewer can confirm the order by selection of an icon or button 23 provided or other suitable use of the control means. At any time, the viewer may clear entered data by selecting the icon or button 25 or continue viewing the image file by selecting the icon or button 26.

After confirmation of the order by the viewer, it is transmitted to a remote server 30 operating the interface for checking. Assuming that the payment details are correct and the order can be, fulfilled, a confirmation message 24 is displayed to the viewer and the viewer is presented with a button or icon 25 enabling the option of resuming viewing operation, as is shown in FIG. 5.

Turning now to FIG. 6, one possible implementation of the means for checking and fulfilling a viewer order is shown. Information from the viewers viewing apparatus is communicated to a server 30. The server 30 is operable to check the viewer's order and billing details. If these are valid, the confirmation message 24 is relayed to the viewer's viewing apparatus. Additionally, the server 30 is operable to communicate the requisite order details to the manufacturer 31 and/or distributor 32 for each of the ordered products. This allows the ordered products 33 to be delivered to the viewer 34 in due course.

This method has the advantage of satisfying viewer curiosity about products in films, computer games and/or television programs whilst further providing a simple way for the viewer to order any products with which they are impressed. This is much simpler for the viewer than researching the product and the manufacturer in order to place an order. Consequently, products featured in this manner might reasonably expect increased sales.

In order to implement the above method, it is necessary to provide modified moving image files. This may be achieved by adding addition data fields into the image file. The additional fields may contain the icons displayed, data indicating when and where a featured product is visible to the viewer and information relating to the featured product.

The invention may be implemented for the viewer via a single device or via a linked system of devices. In order to be suitable to operate the invention, the single device or system must provide the elements illustrated in FIG. 7. Herein, the system 100 comprises a display unit 101, an image file playing means 102, a viewer operable control means 103 and data exchange means 104 by means of which data may be exchanged with the server 30.

As an example, the system may comprise a computer system or may comprise a separate display unit and separate image file player (or of course an integrated display unit and player).

In the case of a computer system, the data exchange means my be a wired or wireless internet or network connection and image files may be read from an internal or external drive or received from a remote location via either a wired or wireless link.

In other cases, the display unit may be a viewer's television (or other display unit) and the player may be any suitable player including but not limited to the television itself, a games console, a media player such as a DVD player or similar, or a satellite or cable television decoder box. A further possibility is that the invention may be implemented through a mobile technology device including but not limited to phones, portable media players, PDAs or similar. In such examples, the control means may be a suitably adapted remote control means.

In particular, the control means might be an integrated or connected (via wired or wireless link) keyboard or keypad, an integrated or connected (via wired or wireless link) pointer device or a touch sensitive screen.

The present invention is implemented using a suitable adapted display device operable to read and display a moving image file. In this description, display device encompasses both a device having an integrated file reader and display unit and a combination of separate file readers and display units.

In one particular embodiment, the invention may be implemented on a media player with a remote control unit adapted to have a ‘hot button’. The hot button may be a dedicated viewer actuable input which automatically selects a tagged product in the currently viewed scene or cycles through two or more tagged products in a viewed scene. An additional hot button may be provided to enable the viewer to complete a purchase.

It is of course to be understood that the invention is not to be restricted to the details of the above embodiment which is described by way of example only.

What is claimed is:

1. A method of providing additional information to a viewer of a moving image file comprising the steps of:
providing one or more tags within the moving image file indicating the existence of additional product information;
visually indicating the existence of said tags alongside or over the moving image;
detecting a request to view said product information associated with said one or more tags;
pausing said moving image; and
displaying said requested product information over said paused image.

2. The method of claim 1, further comprising the step of:
displaying the visual indication of the existence of a tag automatically.

3. The method of claim 1, further comprising the step of:
displaying the visual indication of the existence of a tag in response to a viewer action.

4. The method of claim 3, wherein the viewer action may be a selection of a tag visual indication display mode.

5. The method of claim 4, wherein the tag visual indication display mode may toggle between enabled and not enabled.

6. The method of claim 4, wherein the tag visual indication display mode may be enabled temporarily in response to viewer selection or request.

7. The method of claim 3, wherein tag visual indication is in response to viewer selection of a particular area of the displayed image.

8. The method of claim 1, wherein the visual indication of the existence of a tag comprises displaying a product icon.

9. The method of claim 8, where the product icon is displayed over the tagged product.

10. The method of claim 8, wherein the product icon may is displayed in an icon display area.

11. The method of claim 10, wherein the product icon is a stylized representation of the tagged product.

12. The method of claim 19, wherein the product icon is an image of the tagged product.

13. The method of claim 1, further comprising the step of:
providing an icon display area along one edge of the display area.

14. The method of claim 1, further comprising the step of:
visually highlighting the tagged product within the image.

15. The method of claim 1, further comprising the step of:
providing the displayed information in a window over the paused image.

16. The method of claim 1, wherein the displayed information contains information selected from the group consisting essentially of: a description of the qualities of the product, at least one image of the product, the name of the manufacturer, and purchasing details for the product.

17. The method of claim 1, further comprising the step of:
providing a selectable purchase icon, selection of which enables the connection of the viewer to an electronic commerce interface, for the purchase of said product.

18. The method of claim 17, wherein selection of the purchase icon adds the product to a shopping list.

19. The method of claim 18, further comprising the step of:
providing a selectable checkout icon, selection of which enables the viewer to review their shopping list before completing the purchase process.
